(19) United States
(12) Patent Application Publication
(10) Pub. No.: US 2010/0257472 A1
(43) Pub. Date: Oct. 7, 2010

(54) FILE MANAGING SYSTEM AND ELECTRONIC DEVICE HAVING SAME

(75) Inventor: Yu Zhang, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/489,422

(22) Filed: Jun. 22, 2009

(30) Foreign Application Priority Data
Apr. 3, 2009 (CN) 200910301351.5

(51) Int. Cl. G06F 3/048

(52) U.S. Cl. 715/769

(57) ABSTRACT

A file managing system for use in an electronic device is disclosed. The electronic device includes a storage unit and a multi-touch screen. The storage unit stores a file therein. The file managing system includes a window generating unit, a copy command detecting unit, and a data copy unit. The window generating unit represents the file in the multi-touch screen as a file icon. The copy command detecting unit detects a copy command input involving dragging the file icon back and forth linearly. The data copy unit copies the file to yield a copy of the file if the copy command input is detected.

### BACKGROUND

1. Technical Field

The present disclosure relates to file managing systems and, particularly, to a touch-screen based file managing system and an electronic device having the same.

2. Description of Related Art

Touch screens are now widely used in electronic devices. Accordingly, many touch-screen based file managing systems have been developed. However, these current file managing systems commonly fail to make maximum use of the convenience of the touch screens. For example, when using a current touch-screen based file managing system to copy a file, the following steps are required: triggering a menu by long pressing an icon associated with the file on a touch screen; triggering a “copy” command by tapping a corresponding option of the menu once to reproduce a copy of the file; triggering the menu again by long pressing on any blank area of the touch screen; and triggering a “paste” command by tapping a corresponding option of the menu once to generate a new icon associated with the copy of the file. As can be seen, the steps are complicated and an inconvenience when copying files.

Therefore, it is desirable to provide a touch-screen based file managing system and an electronic device having the same, which can overcome the above-mentioned problems.

### BRIEF DESCRIPTION OF THE DRAWINGS

FIG. 1 is a functional block diagram of an electronic device which includes a multi-touch screen and a storage unit storing a file system therein, according to the disclosure.

FIG. 2 is a schematic view showing a first state of the file system and the multi-touch screen of FIG. 1.

FIG. 3 is a schematic view showing how to operate a select command input and a copy command input on the multi-touch screen of FIG. 1.

FIG. 4 is a schematic view showing how to operate another select command input and the copy command input on the multi-touch screen of FIG. 1.

FIG. 5 is a schematic view showing a second state of the file system and the multi-touch screen of FIG. 1.

FIG. 6 is a schematic view showing a third state of the file system and the multi-touch screen of FIG. 1.

FIG. 7 is a schematic view showing how to operate a move command input on the multi-touch screen of FIG. 1.

FIG. 8 is a schematic view showing a fourth state of the file system and the multi-touch screen of FIG. 1.

FIG. 9 is a schematic view showing how to operate another move command input on the multi-touch screen of FIG. 1.

FIG. 10 is a schematic view showing a fifth state of the file system and the multi-touch screen of FIG. 1.

FIG. 11 is a schematic view showing how to operate another move command input on the multi-touch screen of FIG. 1.

### DETAILED DESCRIPTION

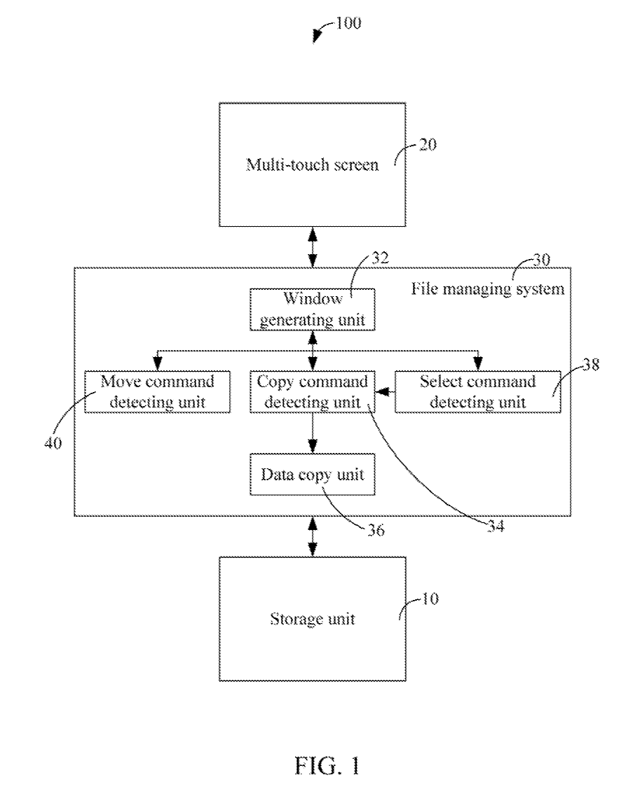

Referring to FIG. 1, an electronic device 100, such as a personal digital assistant (PDA) or a mobile phone, according to an exemplary embodiment, includes a storage unit 10, a multi-touch screen 20, and a file managing system 30.

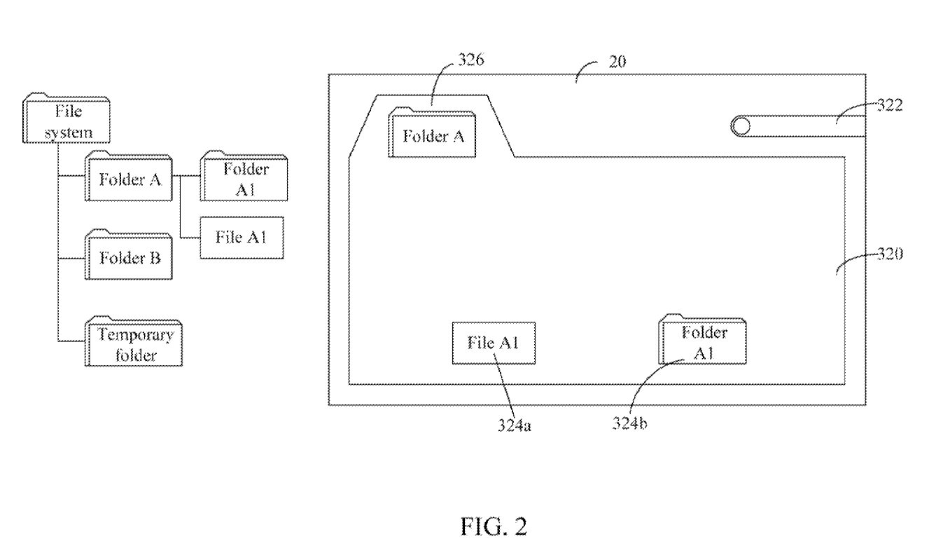

Also referring to FIG. 2, the storage unit 10, such as a secure digital card, is configured for storing a file system. The file system is stored in a form of directory tree and can be modified/manipulated (i.e., managed) by the file managing system 30 (see below). In this embodiment, the file system includes three folders: Folder A, Folder B, and a temporary folder. Folder A includes a subfolder: Folder A1 and a file: File A1.

The multi-touch screen 20, such as a liquid crystal display (LCD) based multi-touch screen, is configured for receiving user inputs and displaying information for users (see below).

The file managing system 30 includes a window generating unit 32, a copy command detecting unit 34, and a data copy unit 36.

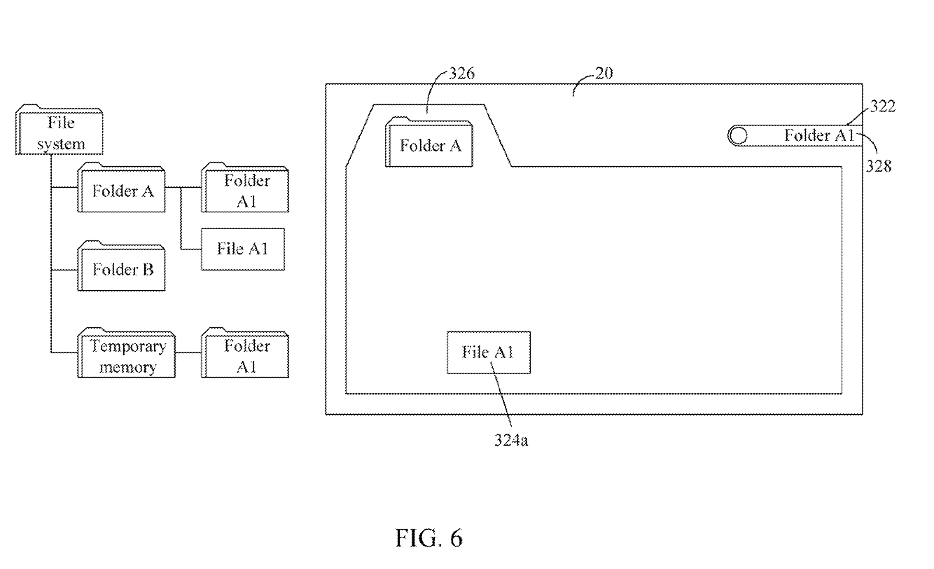

The window generating unit 32 is configured for generating a window 320 and a drop down list 322. The drop down list 322, when extended out, and the window 320 are displayed on the multi-touch screen 20. The window 320 is configured for displaying content(s) in a current folder, if any. The content(s) of the current folder, e.g., file(s) and/or subfolder(s), is represented with a file icon 324a and a folder icon 324b respectively. In particular, the window 320 includes a tab 326. The tab 326 is configured for displaying a tag (not labeled) indicating the current folder. For example, in FIG. 2, the tag indicates that the current folder is Folder A. The drop down list 322 is configured for displaying content(s) in the temporary folder, if any. The content(s) of the temporary folder, e.g., file(s) and/or subfolder(s), is displayed in a form of a list(s) 328 (see FIG. 6).

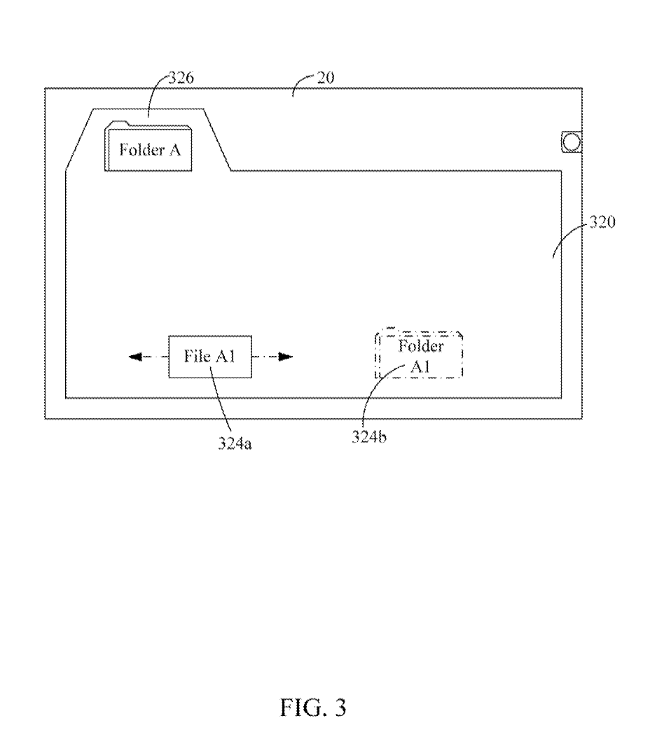

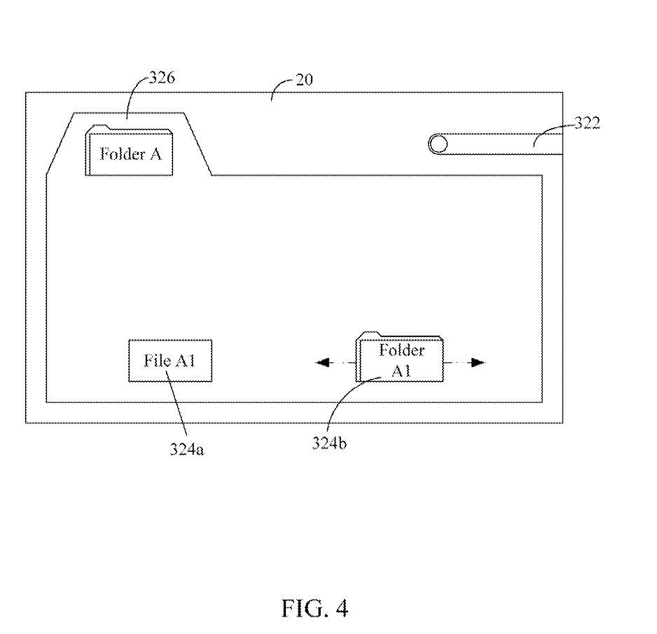

Referring to FIGS. 3-4, the copy command detecting unit 34 is configured for detecting a copy command input that involves dragging a source icon such as a file icon 324a (see FIG. 3) or a folder icon 324b (see FIG. 4) in the window 320 substantially back and forth linearly (shown by the broken line arrows).

The data copy unit 36 is configured for copying a segment of data such as a file or a folder which is represented by the dragged file icon 324a or the dragged folder icon 324b if the copy command input is detected, thereby yielding a copy of data. The copy of data is stored in the storage unit 10.

Referring back to FIG. 1, commonly, the file managing system 30 also includes a select command detecting unit 38. The select command detecting unit 38 is configured for detecting a select command input involving tapping a destination folder icon 324b once or dragging the drop down list 322 outwards.

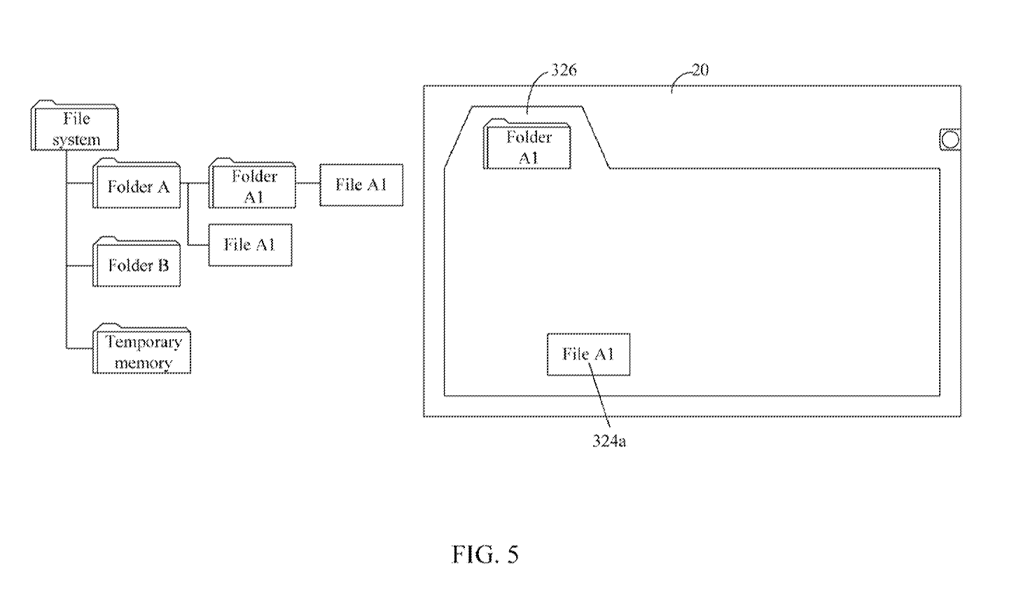

Referring to FIG. 3, if the select command input is performed on the destination folder icon 324b, e.g., icon “Folder A1”, the destination folder icon 324b becomes highlighted, thereby yielding a highlighted icon (shown by a broken line). Accordingly, a corresponding folder is selected. The destination folder icon 324b, e.g., Folder A1, remains highlighted until any other area of the multi-touch screen 20 is tapped. Referring to FIG. 5, in practice, if the copy command input is detected after a folder is selected, the copy of data is sorted into the selected folder by default. After the copy operation, the current folder will automatically change to the selected folder.

Referring to FIG. 6, if the select command input is performed on the drop down list 322, the drop down list 322 extends out (displayed on the multi-touch screen 20). Accordingly, the temporary folder is selected. The state of the temporary folder remains selected with the drop down list 322 extended out until the drop down list 322 is dragged to be hidden again. If the copy command input is detected during the temporary folder is selected, the copy of data is sorted into the temporary folder. After such a copy operation, a list 328 representing the copied data is displayed in the drop down list 322.

Referring back to FIG. 1, the file managing system 30 also includes a move command detecting unit 40. The move command detecting unit 40 is configured for detecting a move command input involving dragging a source icon such as a file icon 324a or a folder icon 324b into a destination folder icon 324b or the drop down list 322, or by dragging a list 328 into the window 320.

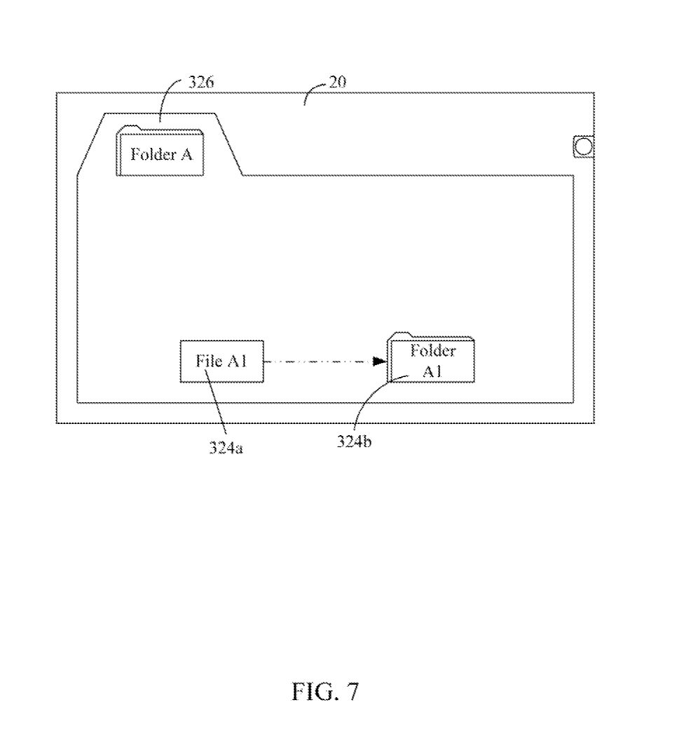

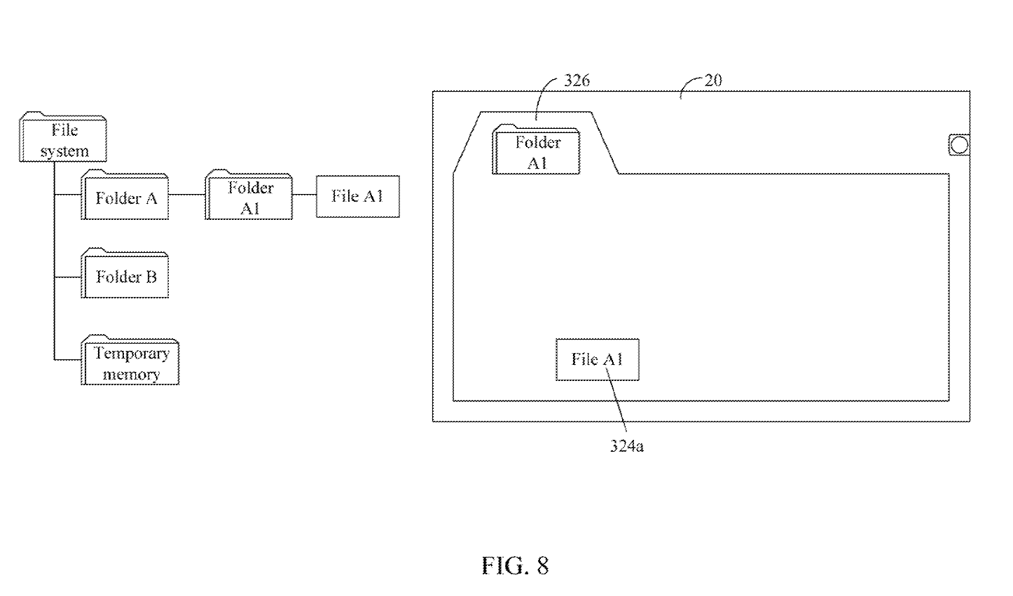

Referring to FIG. 7, if the move command input is performed on a file icon 324a or a folder icon (hereinafter the source icon), e.g., icon “File A”, the move command detecting unit 40 detects whether the target icon is dragged into a folder icon 324b (hereinafter the destination icon), e.g., icon “folder A1”, which is located in the same folder of the source icon (shown by a broken line arrow). Referring to FIG. 8, after the move operation, the file or folder represented by the source icon, e.g., File A, is moved into the folder represented by the destination icon, e.g., Folder A1, and the current folder may automatically change to the folder represented by the destination icon.

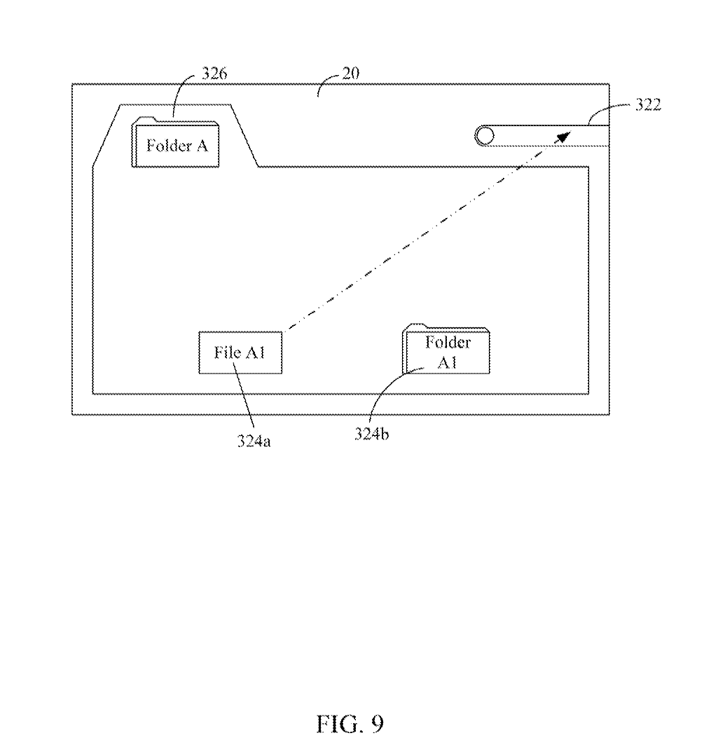

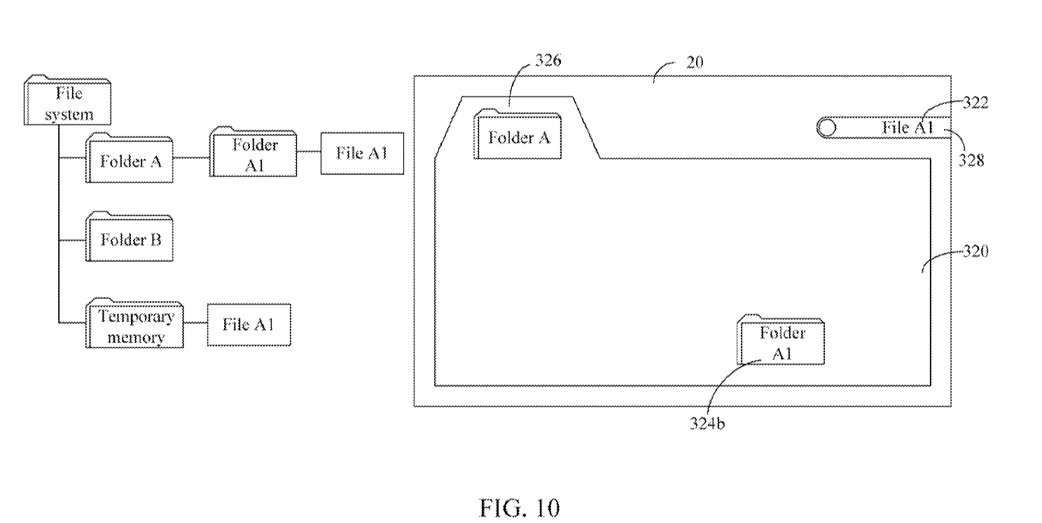

Referring to FIG. 9, it is detected whether the source icon is dragged into the drop down list 322 (shown by a broken line arrow). If yes, referring to FIG. 10, the file or folder represented by the source icon is moved to the temporary folder.

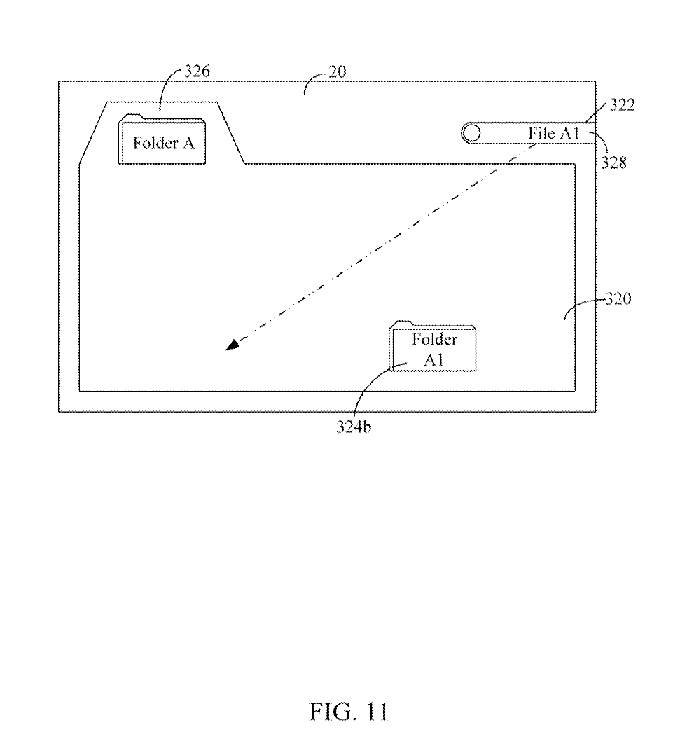

Referring to FIG. 11, if the move command input is performed on a list 328, the move command detecting unit 40 detects whether the list 328 is dragged into the window 320. If yes, referring back to FIG. 2, the file or folder represented by the list 328, e.g., File A, is moved to the current viewed folder, e.g., Folder A.

In particular, in operation, the copy command detecting unit 34, the select command detecting unit 38, and the move command detecting unit 40 all read location information of the window 320, the file icon 324a, the folder icon 324b, the drop down list 322, and the list 328 from the window generating unit 32 and update information of the file system to the window generating unit 32. Thereby, the copy command detecting unit 34, the select command detecting unit 38, and the move command detecting unit 40 can accurately detect the copy command input, the select command input, the move command input correspondingly, and the window generating unit 32 can generating a window 320 and a drop down list 322 corresponding to the current reversion of the file system.

While various exemplary and preferred embodiments have been described, it is to be understood that the invention is not limited thereto. To the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. A file managing system for use in an electronic device, the electronic device comprising a storage unit and a multi-touch screen, the storage unit storing a segment of data, the file managing system comprising:
a window generating unit configured for representing the segment of data in the multi-touch screen as a source icon;
a copy command detecting unit configured for detecting a copy command input involving dragging the source icon back and forth linearly; and
a data copy unit configured for copying the segment of data to yield a copy of data if the copy command input is detected.

2. The file managing system of claim 1, wherein the storage unit stores a file system, the file system comprising at least one folder and at least one file which are organized in a form of folder tree and represented by the window as at least one corresponding folder icon and at least one corresponding file icon, the segment of data being selected from the group consisting of a folder and a file, the source icon being selected from the group consisting of a file icon or a folder icon.

3. The file managing system of claim 2, further comprising a select command detecting unit, the select command detecting unit being configured for detecting a select command input involving tapping a destination folder icon once and selecting the folder represented by the destination folder icon if the select command input is detected.

4. The file managing system of claim 3, wherein the select command unit is configured for highlighting the destination folder icon.

5. The file managing system of claim 3, wherein the select command detecting unit is configured for keeping the selected folder selected until other area of the multi-touch screen is tapped.

6. The file managing system of claim 3, wherein the data copy unit is configured for sorting the copy of the source into the selected folder if the copy command input is detected.

7. The file managing system of claim 2, further comprising a move command detecting unit, the move command detecting unit being configured for detecting a move command input involving dragging the source icon into a destination folder icon and moving the segment of data into the folder represented by the destination folder icon if the move command input is detected.

8. The file managing system of claim 2, wherein the storage unit comprises a temporary folder.

9. The file managing system of claim 8, wherein the window generating unit is configured for generating a drop down list for displaying file(s) or folder(s) contained in the temporary folder.

10. The file managing system of claim 9, wherein the file(s) and folder(s) of the temporary folder are displayed in a form of list.

11. The file managing system of claim 10, further comprising a select command detecting unit, the select command detecting unit being configured for detecting a select command input involving dragging the drop down list outwards and selecting the temporary folder if the select command input is detected.

12. The file managing system of claim 11, wherein select command detecting unit is configured for keeping the temporary folder selected until the drop down list is dragged to be hidden.

13. The file managing system of claim 11, wherein the data copy unit is configured for sorting the copy of the segment of data into the temporary folder if the copy command input is detected when the temporary folder is selected.

14. The file managing system of claim 10, further comprising a move command detecting unit, the move command detecting unit being configured for detecting a move command input involving dragging the source icon into the drop down list and moving the segment of data into the temporary folder if the move command input is detected.

15. The file managing system of claim 10, wherein the window generating unit is configured for generating a window for displaying contents of the current view folder.

16. The file managing system of claim 15, further comprising a move command detecting unit, the move command detecting unit being configured for detecting a move command input involving dragging a list into the window and moving the file or the folder to the current folder.

17. An electronic device comprising:
a storage unit storing a segment of data therein;
a multi-touch screen; and
a file managing system comprising:
a window generating unit configured for representing the segment of data in the multi-touch screen as a source icon;
a copy command detecting unit configured for detecting a copy command input involving dragging the source icon back and forth linearly; and
a data copy unit configured for copying the source to yield a copy of data if the copy command input is detected.
